(19) United States
(12) Patent Application Publication
(10) Pub. No.: US 2009/0328111 A1
(43) Pub. Date: Dec. 31, 2009

(54) Content Distribution System, Server, and Content Distribution Method

(75) Inventor: Yumiko Nakajima, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/396,209

(22) Filed: Mar. 2, 2009

(30) Foreign Application Priority Data
Jun. 27, 2008 (JP) 2008-168260

(51) Int. Cl. H04N 7/18

(52) U.S. Cl. 725/82

(57) ABSTRACT

According to one embodiment, a content distribution system includes a receiver device, a distribution device, and a management device. The distribution device is located in a network, and distributes content to the receiver device. The management device is located in the network, and manages, as user interface information, information on user interface screen to be displayed on the receiver device for operating functions of the distribution device. The management device requests a server located outside the network to create the user interface information, and acquires the user interface information from the server.

### CROSS-REFERENCE TO RELATED APPLICATIONS

This application is based upon and claims the benefit of priority from Japanese Patent Application No. 2008-168260, filed Jun. 27, 2008, the entire contents of which are incorporated herein by reference.

### BACKGROUND

1. Field

One embodiment of the invention relates to a content distribution system, a server, and a content distribution method.

2. Description of the Related Art

There has been proposed the use of a home server to reproduce or record content including video and audio with a plurality of devices in a network.

For example, using the Institute of Electrical and Electronics Engineers (IEEE) 1394 as the interconnection medium, the IEEE 1394-based home audio/video interoperability (HAVi) standard allows different home appliances, such as tuners, recorders (video recorders), televisions, and monitors, to be networked together. Besides, with the spread of asymmetric digital subscriber line (ADSL) and optical fiber networking, communication carriers and Internet providers offer content available as an option in addition to content provided by broadcast carriers.

Meanwhile, a video compression standard called H.264/MPEG-4 advanced video coding (AVC) (often simply referred to as “AVC”) and the continuing fall in the price of large-capacity hard disk drives facilitate the recording of full high-definition video content with high scanning line density (1920 horizontal pixels×1080 vertical pixels) on a recorder (video recorder). Additionally, optical discs according to the high definition (HD) DVD standard are now widely used as recording media. The HD DVD standard is developed from the DVD standard, and HD DVD optical discs have a storage capacity about five times greater than that of DVD optical discs.

Further, recorders, televisions (monitors), and audio video (AV) controllers (AV amplifiers) are equipped with a bidirectional communication interface such as, for example, a high-definition multimedia interface (HDMI). This enables to check the recording/reproducing capability of each device, connection between devices, and the like on a network.

Japanese Patent Application Publication (KOKAI) No. H09-331517 discloses a video on demand (VOD) system comprising a video server that distributes digital video data, a VOD client that receives the digital video data and displays it, a web server that distributes file data, and a web client that receives a web file. The VOD system has a function of analyzing the web file and activating other functions. With this VOD system, an image can be automatically displayed through a graphical user interface (GUI) of the Web client without being regarded as a VOD file.

Japanese Patent Application Publication (KOKAI) No. 2002-83485 discloses an AV network system comprising a home server that generates a table of information by arranging management information of tape media and disk media, and displays it on a display device. With the AV network system, information can be managed in an integrated manner and user operability can be improved.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a home network to which are applied a content distribution system and a server according to an embodiment of the invention;

FIG. 2 is an exemplary block diagram of a distribution device installed in the home network in the embodiment;

FIG. 3 is an exemplary block diagram of a receiver device installed in the home network in the embodiment;

FIG. 4 is an exemplary sequence diagram of a first example of the operation of the distribution device, the receiver device, an NT agent, and a GUI creation server in the embodiment;

FIGS. 5A and 5B are exemplary schematic diagrams of the home network before and after a new distribution device is installed therein, respectively, in the embodiment;

FIGS. 6A and 6B are exemplary tables indicating function management information before and after the installation of a new distribution device, respectively, in the embodiment;

FIGS. 7A and 7B are exemplary schematic diagrams of GUI before and after the installation of a new distribution device, respectively, in the embodiment;

FIG. 8 is an exemplary sequence diagram of a second example of the operation of the distribution device, the receiver device, the NT agent, and the GUI creation server in the embodiment;

FIG. 9 is an exemplary schematic diagram of a screen displaying a plurality of GUI samples in different designs in the embodiment;

FIGS. 10A and 10B are exemplary schematic diagrams of a GUI before and after the design changes, respectively, in the embodiment;

FIG. 11 is an exemplary sequence diagram of a third example of the operation of the distribution device, the receiver device, the NT agent, and the GUI creation server in the embodiment; and

FIGS. 12A and 12B are exemplary schematic diagrams of a GUI before and after update, respectively, in the embodiment

### DETAILED DESCRIPTION

Various embodiments according to the invention will be described hereinafter with reference to the accompanying drawings. In general, according to one embodiment of the invention, a content distribution system comprises: a receiver device; a distribution device located in a network, the distribution device configured to distribute content to the receiver device; and a management device located in the network, the management device configured to manage, as user interface information, information on user interface screen to be displayed on the receiver device for operating functions of the distribution device. The management device is configured to request a server located outside the network to create the user interface information, and acquires the user interface information from the server.

According to another embodiment of the invention, a server is located outside a network where a management device manages, as user interface information, information on user interface screen to be displayed on a receiver device for operating functions of a distribution device that distributes content to the receiver device. The server is configured to create the user interface information and provide the user interface information to the management device.

According to still another embodiment of the invention, a content distribution method comprises: creating, outside a network, information on user interface screen to be displayed on a receiver device for operating functions of a distribution device that distributes content to the receiver device in the network; and providing the information to the network.

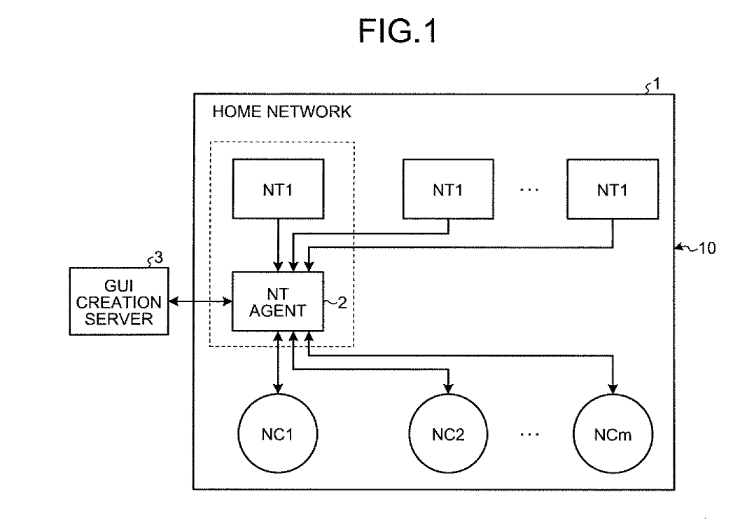

FIG. 1 is a schematic diagram of a home network 1 to which are applied a content distribution system and a server according to an embodiment of the invention. As illustrated in FIG. 1, the home network (network) 1 comprises a plurality of receiver devices (network clients) NC1 to NCm, a plurality of distribution devices (network tuners) NT1 to NTn, and a network tuner (NT) agent (management device) 2. The receiver devices NC1 to NCm may be televisions, while the distribution devices NT1 to NTn may be tuners. The NT agent 2 interconnects the receiver devices NC1 to NCm and the distribution devices NT1 to NTn together. The receiver devices NC1 to NCm and the NT agent 2 constitute a content distribution system 10.

The NT agent 2 collects and manages function information provided by the distribution devices NT1 to NTn. According to the function information, the NT agent 2 provides the receiver devices NC1 to NCm with a graphical user interface (GUI) screen that enables the functions of the distribution devices NT1 to NTn to be operated in an integrated manner. In other words, in the home network 1, the NT agent 2 manages information as to a GUI to be displayed on each of the receiver devices NC1 to NCm for operating the functions of each of the distribution devices NT1 to NTn. The NT agent 2 maybe integrated with any of the distribution devices NT1 to NTn, or may be provided separately.

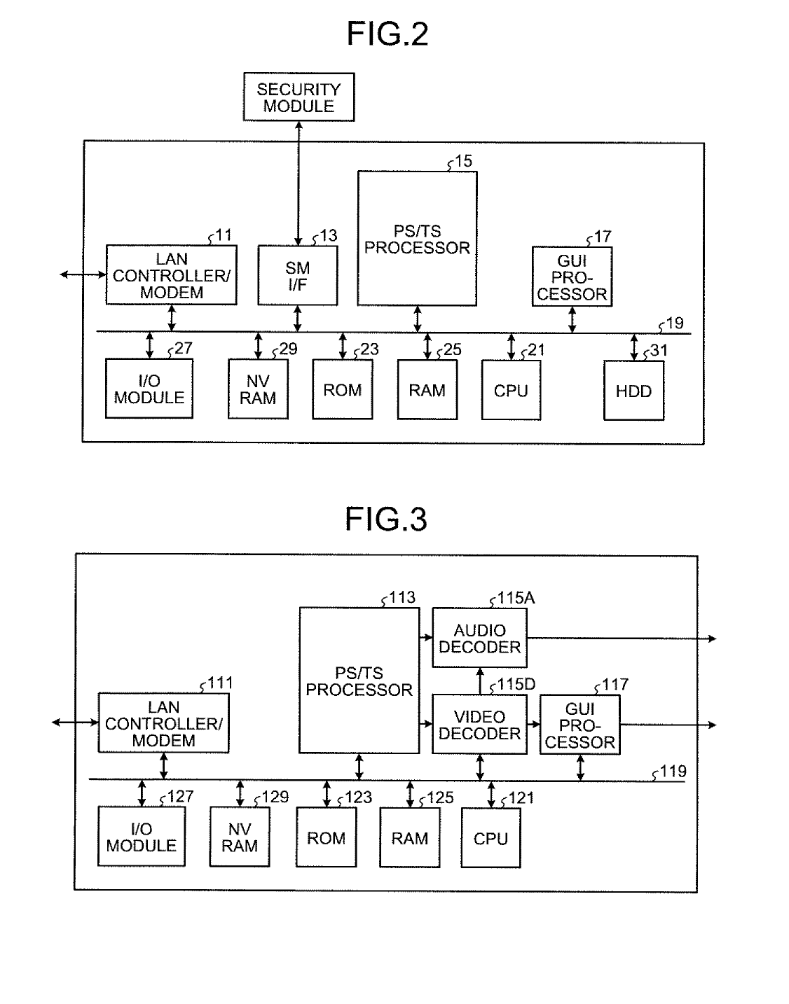

The distribution devices NT1 to NTn each redistribute broadcast content to the receiver devices NC1 to NCm in the home network 1. FIG. 2 is a block diagram of the distribution device installed in the home network 1.

As illustrated in FIG. 2, the distribution devices NT1 to NTn each comprise a local area network (LAN) controller/modem 11, a security module interface (SM I/F) 13, a packet sized stream (PS) /transport stream (TS) processor 15, a GUI processor 17, and a bus 19 that interconnects them.

The distribution devices NT1 to NTn each further comprise a central processing unit (CPU) 21, a read only memory (ROM) 23, a random access memory (RAM) 25, an input/output (I/O) module 27, a non-volatile random access memory (NVRAM) 29, which are also interconnected by the bus 19. The CPU 21 is a master controller. The ROM 23 stores operation programs for the CPU. The RAM 25 is used as a work memory. The I/O module 27 comprises a tuner, and receives/outputs video and audio (content) as well as receiving a control signal input by a user (selection of a channel through the tuner). The NVRAM 29 stores, for example, information set by a user and programmed information. The distribution devices NT1 to NTn may each further comprise a hard disk drive (HDD) 31 as a large capacity storage device, and, although not shown in the drawings, a disk drive (recorder) capable of recording acquired content on a digital versatile disc (DVD) optical disk or a high definition (HD) DVD optical disk. The distribution devices NT1 to NTn may each further comprise a semiconductor memory (referred sometimes to as flash memory or memory card) and the like.

The distribution devices NT1 to NTn configured as above have at least a tuner function so that it can select and receive various contents (video, audio, etc.) as graphical files, or a specific channel or program provided by a broadcast carrier or a communication carrier. For example, the distribution devices NT1 to NTn may be provided with a television (TV) tuner capable of receiving air-wave (terrestrial) TV broadcasting and satellite broadcasting from broadcast satellites. The distribution devices NT1 to NTn may also be provided with a cable TV tuner (referred sometimes to as set top box (STB)) capable of receiving video content from a cable TV station, a modem or a splitter capable of receiving content from a communication carrier or an Internet provider, or a function of receiving IPTV services.

The receiver devices NC1 to NCm each displays a GUI provided from the NT agent 2 to a user. The receiver devices NC1 to NCm each communicate with the distribution devices NT1 to NTn via the NT agent 2 through the GUI, and receive content redistributed by the distribution devices NT1 to NTn. The user operates the functions of the distribution devices NT1 to NTn through the GUI, thereby enjoying content redistributed by the distribution devices NT1 to NTn. FIG. 3 is a block diagram of the receiver device installed in the home network 1 illustrated in FIG. 1.

As illustrated in FIG. 3, the receiver devices NC1 to NCm each comprise a LAN controller/modem 111, a PS/TS processor 113, an audio decoder 115A, a video decoder 115D, a GUI processor 117, and a bus 119 that interconnects them. The audio decoder 115A decodes an audio signal. The video decoder 115D decodes a video signal.

The receiver devices NC1 to NCm each further comprise a CPU 121, a ROM 123, a RAM 125, an I/O module 127, an NVRAM 129, which are also interconnected by the bus 119. The CPU 121 is a master controller. The I/O module 127 receives/outputs video and audio (content) from/to the distribution devices NT1 to NTn as well as receiving a control signal input by a user (selection of a channel through the tuner) The NVRAM 29 stores, for example, information set by a user.

The receiver devices NC1 to NCm configured as above function as reproduction devices that output audio and video content provided from the distribution devices NT1 to NTn. Examples of those that receive the audio and video content output from the receiver devices NC1 to NCm include a monitor (display) device, an audio amplifier (controller) and a speaker set connected to the audio amplifier, a personal computer (PC) connected to a communication network, and an arbitrary number of TV receivers installed at home.

As illustrated in FIG. 1, the NT agent 2 is connected to a GUI creation server (server) 3 located outside the home network 1. The GUI creation server 3 creates a GUI (information on user interface screen) outside the home network 1 in response to a request from the NT agent 2, and provides the GUI to the NT agent 2.

Described below is the operation of the distribution devices NT1 to NTn, the receiver devices NC1 to NCm, the NT agent 2, and the GUI creation server 3.

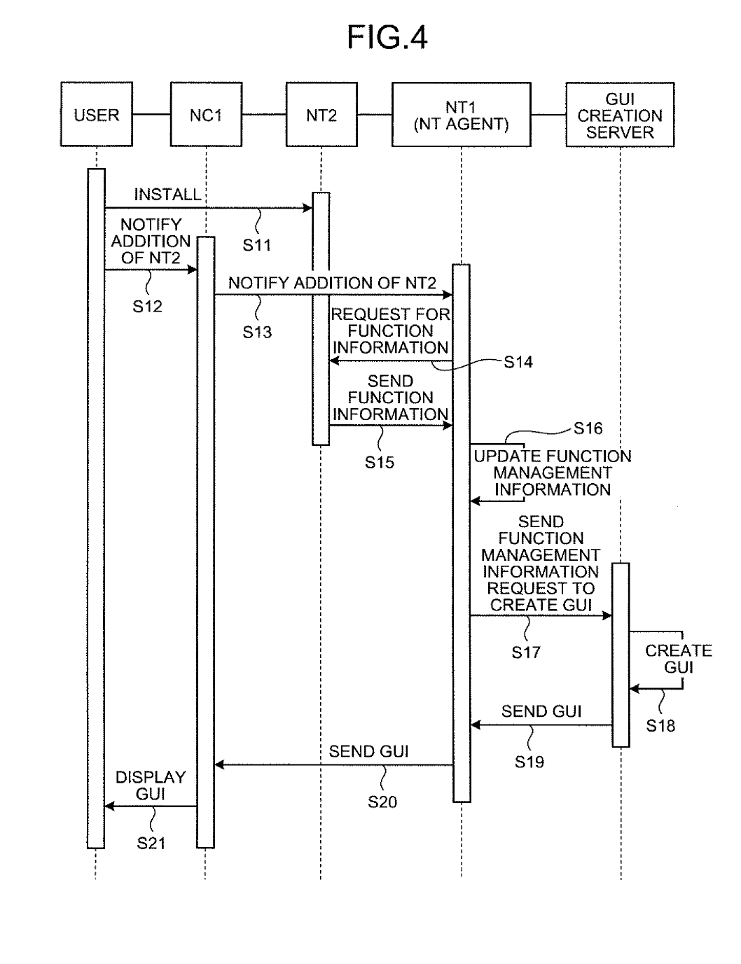

FIG. 4 is a sequence diagram of a first example of the operation of the distribution device, the receiver device, the NT agent, and the GUI creation server. The first example describes the case where the NT agent 2 requests the GUI creation server 3 to create a new GUI when a new distribution device (NT2) is installed in the home network 1 in addition to an existing distribution device (NT1), and thereby acquires a new GUI from the GUI creation server 3.

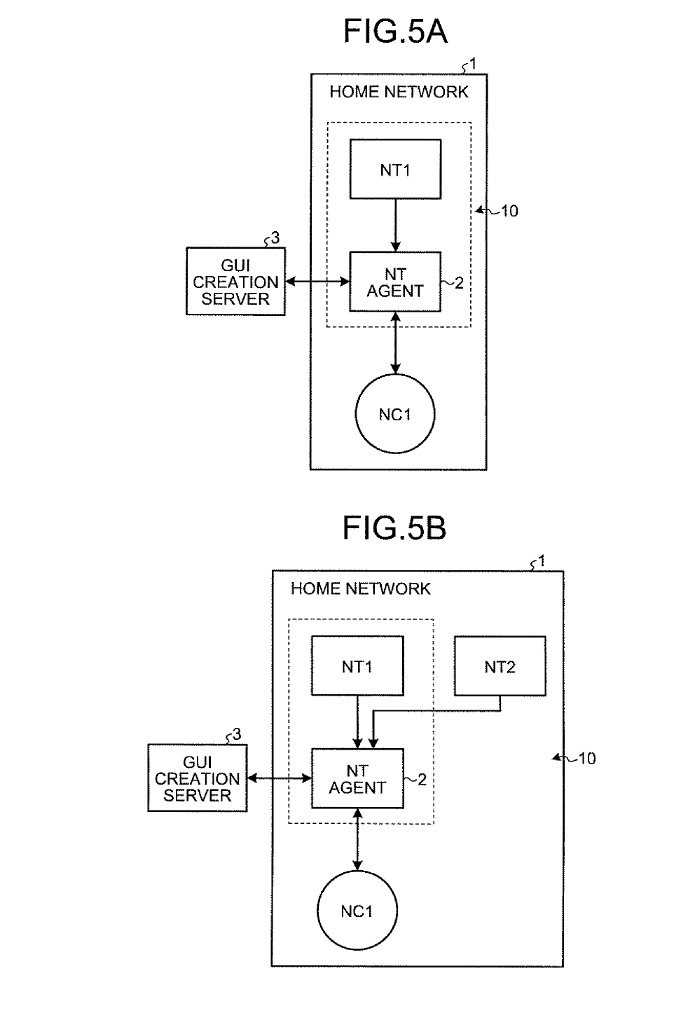

First, a user installs the new distribution device NT2 in the home network 1 (S11). The user then notifies the NT agent 2 of the installation of the new distribution device NT2 through a GUI displayed on the receiver device NC1 (S12 and S13). FIG. 5A is a schematic diagram of the home network 1 before the new distribution device NT2 is installed therein. FIG. 5B is a schematic diagram of the home network 1 after the new distribution device NT2 is installed therein.

Having been notified of the event, the NT agent 2 requests all the distribution devices NT1 and NT2 in the home network 1 for their function information (S14). In response to the request from the NT agent 2, the distribution devices NT1 and NT2 each provide the function information to the NT agent 2 (S15).

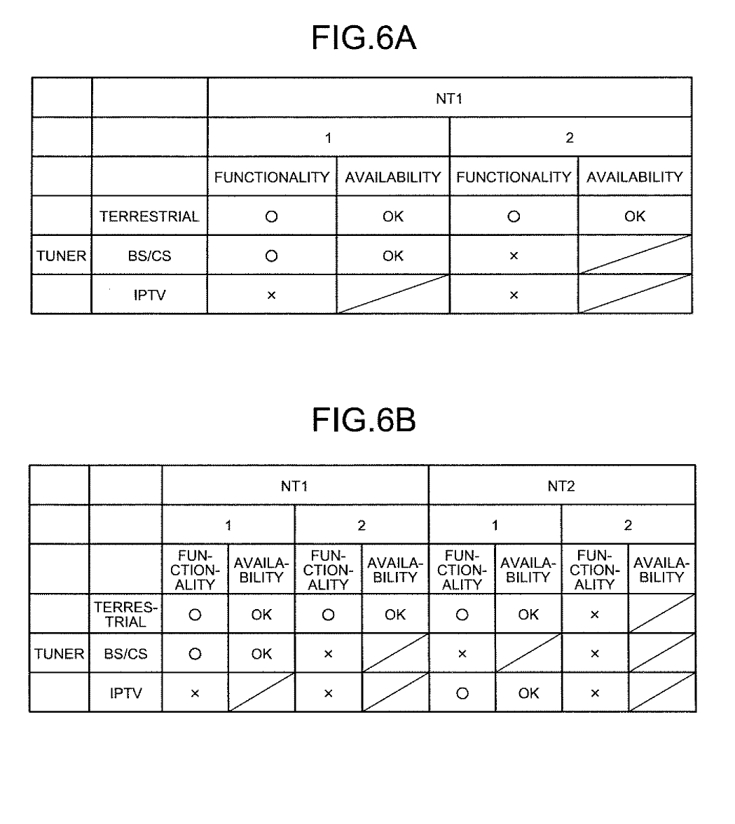

Upon receipt of the function information from the distribution devices NT1 and NT2, the NT agent 2 updates function management information based on the function information (S16). The NT agent 2 then sends the update function management information to the GUI creation server 3 and requests it to create a new GUI (S17). FIG. 6A is a table indicating the function management information before the installation of the new distribution device NT2. FIG. 6B is a table indicating the function management information after the installation of the new distribution device NT2. The update function management information indicates that the distribution of Internet protocol television (IPTV) content newly becomes available due to the installation of the distribution device NT2.

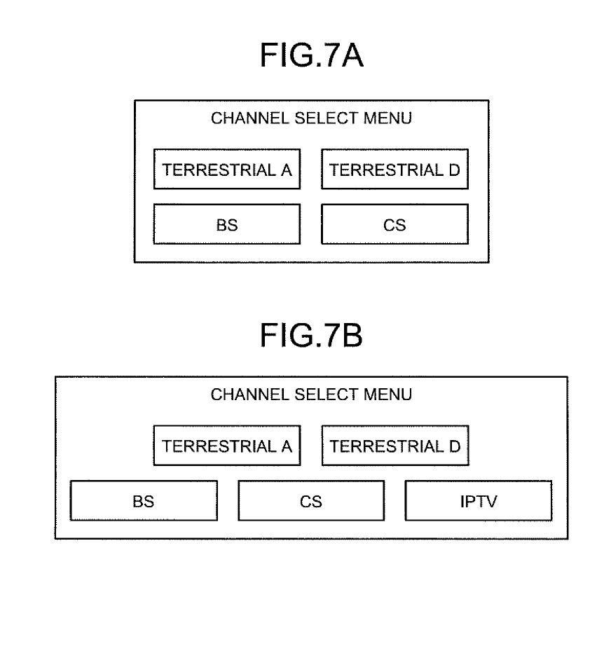

The GUI creation server 3 creates a new GUI based on the function management information received from the NT agent 2 (S18), and sends it to the NT agent 2 (S19). FIG. 7A is a schematic diagram of a GUI before the installation of the new distribution device NT2. FIG. 7B is a schematic diagram of the GUI after the installation of the new distribution device NT2. The new GUI has an extra menu item for selecting the IPTV the distribution of which becomes available with the distribution device NT2.

The NT agent 2 sends the new GUI received from the GUI creation server 3 to the receiver device NC1 (S20). Having received the new GUI from the NT agent 2, the receiver device NC1 displays it to the user (S21).

Although the foregoing describes that the NT agent 2 requests the GUI creation server 3 to create a new GUI when a new distribution device is added to the home network 1, this may not always be the case. For example, the NT agent 2 requests the GUI creation server 3 to create a new GUI also when an existing distribution device is removed from the home network 1 and acquires the new GUI from the GUI creation server 3.

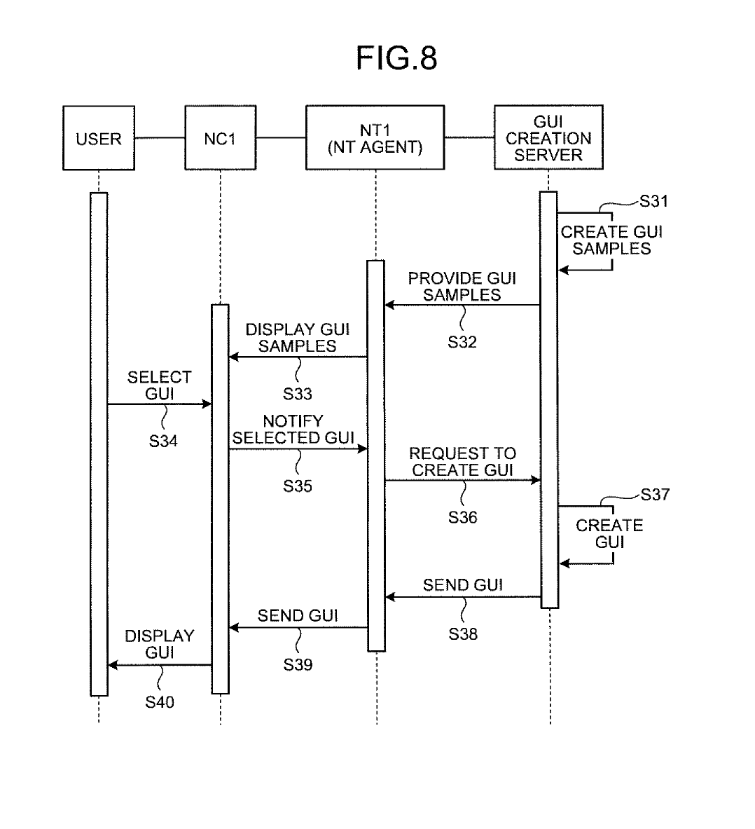

FIG. 8 is a sequence diagram of a second example of the operation of the distribution device, the receiver device, the NT agent, and the GUI creation server. The second example describes the case where the NT agent 2 requests the GUI creation server 3 to create a new GUI upon receiving a request from a user through the receiver device NC1 to change an existing GUI, and thereby acquires a new GUI from the GUI creation server 3.

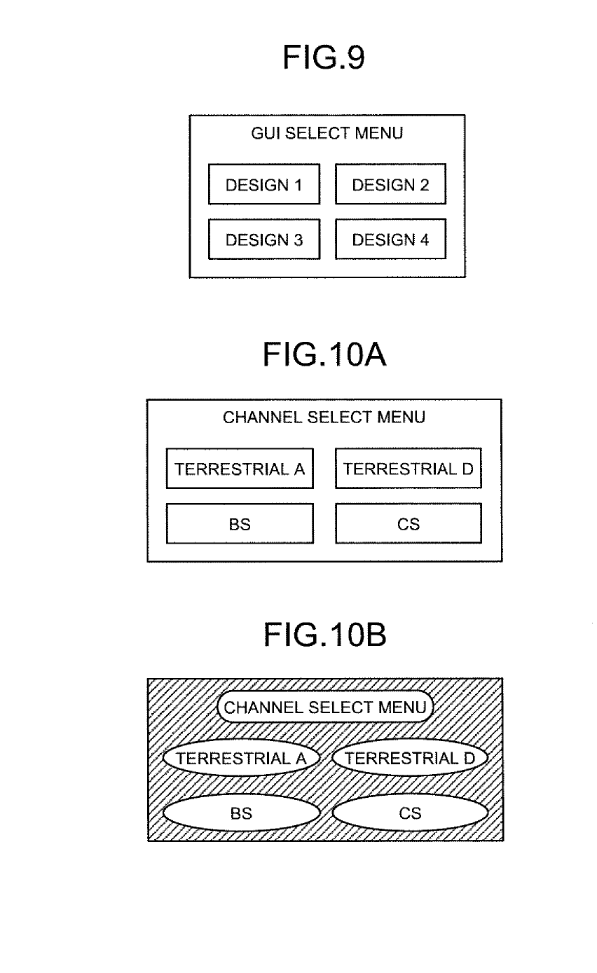

First, the GUI creation server 3 creates a plurality of GUI samples in different designs (S32), and provides them to the NT agent 2. The NT agent 2 displays the GUI samples to the user through the GUI of the receiver device NC1 (S33). FIG. 9 is a schematic diagram of a screen displaying a plurality of GUI samples in different designs.

The user selects a GUI sample in a desired design (S34). The receiver device NC1 notifies the NT agent 2 of GUI design selected by the user (S35). The NT agent 2 requests the GUI creation server 3 to create a new GUI of the selected GUI design (S36).

The GUI creation server 3 creates a new GUI of the design requested by the NT agent 2 (S37), and sends the new GUI to the NT agent 2 (S38). FIG. 10A is a schematic diagram of a GUI before the design changes. FIG. 10B is a schematic diagram of the GUI after the design changes.

Upon receipt of the new GUI from the GUI creation server 3, the NT agent 2 sends it to the receiver device NC1 (S39). Upon receipt of the new GUI from the NT agent 2, the receiver device NC1 displays it to the user (S40).

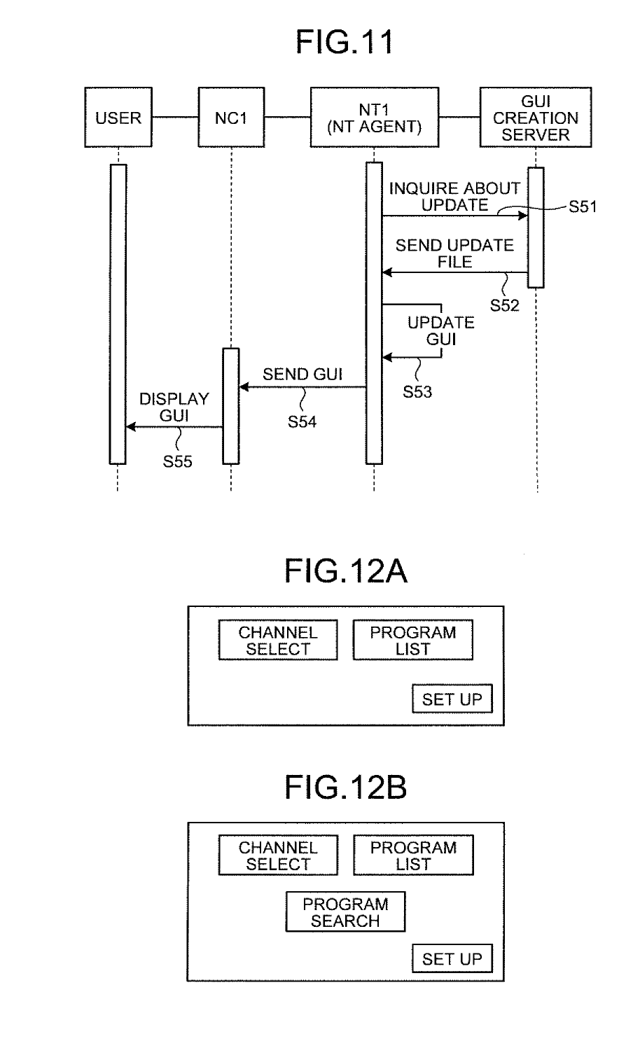

FIG. 11 is a sequence diagram of a third example of the operation of the distribution device, the receiver device, the NT agent, and the GUI creation server. The third example describes the case where the NT agent 2 acquires, upon update of a GUI, information on the update of the GUI from the GUI creation server 3.

First, the NT agent 2 inquires of the GUI creation server 3 whether there is any update item for a GUI (S51). In response to the inquiry from the NT agent 2, the GUI creation server 3 sends, if there is an update item for the GUI of the NT agent 2, an update file to the NT agent 2 (S52).

The NT agent 2 updates the GUI using the update file received from the GUI creation server 3 (S53). FIG. 12A is a schematic diagram of the GUI before update. FIG. 12B is a schematic diagram of the GUI after update.

The NT agent 2 then sends the update GUI to the receiver device NC1 (S54). Upon receipt of the update GUI from the NT agent 2, the receiver device NC1 displays it to the user (S55).

In the operation described above, the NT agent 2 may request, upon update of a GUI, the GUI creation server 3 to create a new GUI, and acquire the new GUI therefrom.

As described above, according to the embodiment, the NT agent 2 of the content distribution system 10 requests the GUI creation server 3, which is located outside the home network 1, to create a GUI. Thus, the NT agent 2 acquires the GUI from the GUI creation server 3. Since an external server creates a GUI in this manner, an appropriate GUI can be flexibly created in response to a change in the configuration, function or the like of the home network 1, a request from a user, or an update event.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content distribution system comprising:
a receiver device;
a distribution device located in a network, the distribution device configured to distribute content to the receiver device; and
a management device located in the network, the management device configured to manage, as user interface information, information on user interface screen to be displayed on the receiver device for operating functions of the distribution device, wherein
the management device is configured to request a server located outside the network to create the user interface information, and acquires the user interface information from the server.

2. The content distribution system of claim 1, wherein the management device is configured to request the server to create the user interface information at least when a new distribution device is added to the network or when an existing distribution device is removed from the network.

3. The content distribution system of claim 1, wherein the management device is configured to request the server to create the user interface information upon receipt of a request from the receiver device to change the user interface screen.

4. The content distribution system of claim 1, wherein the management device is configured to request the server to create the user interface information upon updating the user interface screen.

5. A server located outside a network where a management device manages, as user interface information, information on user interface screen to be displayed on a receiver device for operating functions of a distribution device that distributes content to the receiver device, the server configured to create the user interface information and provide the user interface information to the management device.

6. A content distribution method comprising:
creating, outside a network, information on user interface screen to be displayed on a receiver device for operating functions of a distribution device that distributes content to the receiver device in the network; and
providing the information to the network.
